(19) United States
(12) Patent Application Publication
(10) Pub. No.: US 2026/0044368 A1
(43) Pub. Date: Feb. 12, 2026

(54) GENERATING AND IMPLEMENTING WORKFLOW STATES ACROSS MULTIPLE CLIENT DEVICES

(71) Applicant: Dropbox, Inc., San Francisco, CA (US)

(72) Inventors: Lawrence Ntim, Los Angeles, CA (US); Christopher Oladapo, Los Angeles, CA (US)

(21) Appl. No.: 18/800,787

(22) Filed: Aug. 12, 2024

(51) Int. Cl. G06F 9/48

(52) U.S. Cl. CPC G06F 9/4856; G06F 2209/482

(57) ABSTRACT

The present disclosure is directed toward systems, methods, and non-transitory computer readable media for generating and implementing workflow states across multiple devices. In some embodiments, the disclosed systems generate, utilizing a meta layer integrated with a suite of computer applications, a workflow state defining an active computer application and interaction data within the active computer application on a first client device. Further, in some embodiments, the disclosed systems detect a handoff trigger comprising computer instructions for transferring the workflow state from the first client device to a second client device. In response to detecting the handoff trigger, in some embodiments, the disclosed systems access, via the meta layer, the workflow state to cause the second client device to instantiate the active computer application and the interaction data.

### BACKGROUND

Advancements in computing devices and networking technology have given rise to a variety of innovations in collaborative digital content creation, storage, and sharing. For example, existing online sharing systems can provide devices all over the world access to digital content stored in the cloud. Existing data management systems can also synchronize changes to shared digital content across different types of devices operating on different platforms. Indeed, existing data management systems can provide access to digital content within which users can collaborate from across diverse geographic locations using a variety of computing devices. Despite these advances, however, existing data management systems continue to suffer from a variety of disadvantages, particularly in terms of flexibility and efficiency.

In particular, many existing systems provide limited options for transferring workflow across different devices. For example, interruptions in productivity often occur during user interactions with digital content when a user needs to change locations or devices while continuing to create or collaborate within the digital content. When switching between devices, however, many existing systems require a user to reopen digital content, re-navigate to a working location within the digital content, and re-enter or restart any unsubmitted or uncompleted tasks in order to continue the user's previous workflow. Indeed, such requirements for continuing workflow when switching between devices often results in decreased productivity and efficiency due to the inherent inflexibility of existing systems that results in cumbersome transfer of workflow progress between devices.

These, along with additional problems and disadvantages exist in existing data management systems.

### SUMMARY

This disclosure describes one or more embodiments of systems, methods, and non-transitory computer readable storage media that provide benefits and/or solve one or more of the foregoing and other problems in the art. For instance, the disclosed systems utilize a meta layer integrated with a suite of computer applications to generate and implement workflow states across multiple client devices. For example, the disclosed systems determine a workflow state defining at least one active computer application and interaction data (e.g., defining an incomplete task, content item, or workflow) within the at least one active computer application on a client device. Moreover, the disclosed systems can access the workflow state on another client device to instantiate the at least one active computer application and the interaction data for continued workflow. The disclosed systems can also utilize the aforementioned meta layer to configure a workflow state in a device-agnostic format, such that the workflow state can be transferred to different types of client devices and can be done mid workflow or mid task.

### BRIEF DESCRIPTION OF THE DRAWINGS

This disclosure will describe one or more example implementations of the systems and methods with additional specificity and detail by referencing the accompanying figures. The following paragraphs briefly describe those figures.

FIG. 1 illustrates a schematic diagram of an example environment of a workflow continuance system in accordance with one or more embodiments.

FIG. 2 illustrates an example overview of generating and implementing a workflow state across multiple client devices in accordance with one or more embodiments.

FIG. 3 illustrates an example diagram for generating a workflow state in accordance with one or more embodiments.

FIGS. 4A-4B illustrate example user interfaces for transferring a workflow state from an active computer application on a first client device to a related computer application on a second client device in accordance with one or more embodiments.

FIGS. 5A-5B illustrate example user interfaces for transferring a workflow state comprising multiple active computer applications on a first client device to one or more related computer applications on a second client device in accordance with one or more embodiments.

FIG. 6 illustrates an example series of acts for generating and implementing a workflow state across multiple client devices in accordance with one or more embodiments.

FIG. 7 illustrates a block diagram of an exemplary computing device in accordance with one or more embodiments.

FIG. 8 illustrates an example environment of a networking system having the workflow continuance system in accordance with one or more embodiments.

### DETAILED DESCRIPTION

This disclosure describes one or more embodiments of a workflow continuance system that generates and implements workflow states across multiple client devices. For example, the workflow continuance system generates a workflow state defining an active computer application and interaction data within the active computer application and transfers the workflow state from one client device to another in response to a handoff trigger. In some embodiments, the workflow continuance system utilizes a meta layer integrated with a suite of computer applications to generate and implement the workflow state across devices. In doing so, the workflow continuance system provides for a seamless handoff of the workflow state from one device to another.

In one or more embodiments, the workflow continuance system integrates the aforementioned meta layer with a plurality of related applications across different devices to generate workflow states in a cross-compatible format for computer devices of different device types. To illustrate, in transferring a workflow state from a first client device, such as a personal computer, to a second client device of a different device type, such as a tablet or mobile device, the workflow continuance system can utilize the meta layer to instruct the second client device to instantiate computer applications related to any active computer applications within the workflow state (e.g., applications open on the first client device when the workflow state was generated) with corresponding interaction data translated for display and use on the second client device.

In certain embodiments, the transferable workflow state generated by the workflow continuance system can be an application-specific workflow state or a global workflow state (e.g., a workflow involving more than one active computer application). In an application-specific workflow state, for example, the workflow continuance system can determine and save a cursor location, a current action (e.g., a state of typing, drawing, or other user input), and/or an incomplete application process within the corresponding active computer application. In a global workflow state, the workflow continuance system can determine and save application-specific workflow states for multiple computer applications and, in some cases, can determine and save relationships between the applications and/or tabs within the applications (e.g., to identify and implement application-specific workflow states related to a particular topic/task).

Furthermore, in various embodiments, the workflow continuance system can detect one or more of a variety of handoff triggers that indicate when to transfer a current workflow state from one client device to another, including but not limited to user interactions with a selectable option on either client device, detection of respective idle or active statuses of client devices, user interactions with client devices and/or peripheral devices thereof, and so forth.

As suggested above, the workflow continuance system can provide several improvements or advantages over existing data management systems. For example, embodiments of the workflow continuance system can improve flexibility over prior systems. To illustrate, many existing systems provide related applications across multiple devices, but such systems generally require users to navigate to each related application—and each content item the user wishes to access—individually on their respective devices. In contrast to this inflexibility of existing systems, the workflow continuance system provides for seamless transference of workflow states across different devices. Indeed, through the meta layer for saving and transferring specific edited data states within one or more applications, the workflow continuance system can significantly improve the flexibility with which users can switch between devices without interrupting their current workflow in related applications on those devices.

Similarly, due at least in part to improving flexibility over prior systems, the workflow continuance system can also improve efficiency over such systems. As an example, the workflow continuance system can provide more efficient user interfaces that reduce the number of user interactions required to access desired data or functionality. Specifically, the workflow continuance system provides for seamless transference of workflow states between different devices, thus allowing users to continue workflow in a productive, uninterrupted manner. In contrast to the seamless continuance of workflow provided by the workflow continuance system, existing systems generally require the user to instantiate programs, access individual content items, navigate to a location within each content item where the user was previously working, and reinitiate any incomplete user inputs or applications processes. Consequently, the workflow continuance system further saves computing resources that prior systems expend processing relatively larger numbers of duplicative user interactions for reinitiating workflow states when switching between devices.

As illustrated by the foregoing discussion, the present disclosure utilizes a variety of terms to describe features and benefits of the workflow continuance system. Additional detail is hereafter provided regarding the meaning of these terms as used in this disclosure. As used herein, the term “digital content item” (or simply “content item”) refers to a digital object or a digital file that includes information interpretable by a computing device (e.g., a client device) to present information to a user. A digital content item can include a file or a folder such as a digital text file, a digital image file, a digital audio file, a webpage, a website, a digital video file, a web file, a link, a digital document file, or some other type of file or digital object. A digital content item can have a particular file type or file format, which may differ for different types of digital content items (e.g., digital documents, digital images, digital videos, or digital audio files). In some cases, a digital content item can refer to a remotely stored (e.g., cloud-based) item or a link (e.g., a link or reference to a cloud-based item or a web-based content item) and/or a content clip that indicates (or links/references) a discrete selection or segmented sub-portion of content from a webpage or some other content item or source. A content item can also include application-specific content that is siloed to a particular computer application but is not necessarily accessible via a file system or via a network connection. A digital content item can be editable or otherwise modifiable and can also be sharable from one user account (or client device) to another. In some cases, a digital content item is modifiable by multiple user accounts (or client devices) simultaneously and/or at different times.

As used herein, the term “meta layer” refers to a functional layer of a computer system that operates above or beyond other layers in the system to provide overarching control, integration, or abstraction to the overall system. For example, a meta layer includes or refers to a segment of computer code executable by the workflow continuance system and/or a content management system to manage or maintain environmental constraints and communication data across multiple subsystems and/or devices connected with the content management system (e.g., as an added code layer on top of device-specific applications or other system functions). In some embodiments, for example, the workflow continuance system utilizes a meta layer integrated with a suite of computer applications, such as a connected suite hosted by a content management system (or other integrated system) or otherwise interlinked across a computer network (e.g., via APIs or other operating protocols). In some embodiments, a system's meta layer comprises an abstraction layer that provides a unified interface to interact with various applications and data sources within the aforementioned suite of computer applications. Also, in certain embodiments, a meta layer implements API protocols and/or connectors to integrate features across multiple devices as they access the suite of computer applications.

Relatedly, as used herein, the term “connector” refers to a computer code segment, application, or program that retrieves or extracts features that define information from user-account-facing applications, such as digital calendars, video call applications, email applications, text messaging applications, and other applications. In some cases, a connector is as described by Vasanth Krishna Namasivayam et al. in U.S. patent application Nos. Ser. No. 18/478,061 and 18/478,066, titled GENERATING AND MAINTAINING COMPOSITE ACTIONS UTILIZING LARGE LANGUAGE MODELS, filed Sep. 29, 2023, both of which are incorporated herein by reference in their entireties.

As used herein, the term “workflow state” refers to a specific condition or stage within a workflow process wherein particular tasks or actions are being performed. For example, a workflow state can include or refer to a state of computer data across one or more computer applications, where the data state includes, stores, saves, or defines states of application tabs/windows as well as states of content items edited or modified within the application tabs/windows at a point in time. Indeed, a workflow state can indicate a current editing point of a content item within an application at a point in time, including previously entered but incomplete or unsaved modifications. A workflow state can include location data for where applications tabs/windows are located in a display and/or can include location data for where content items (and content within the content items) are located in the display. In particular embodiments, for example, the workflow continuance system generates a workflow state defining at least one active computer application on a particular client device and interaction data within that at least one active computer application on the particular client device. In some cases, the workflow continuance system 102 saves a workflow state as a content item by assigning storage memory to the workflow state as a data object that is accessible by one or more client devices for restoration and continuance.

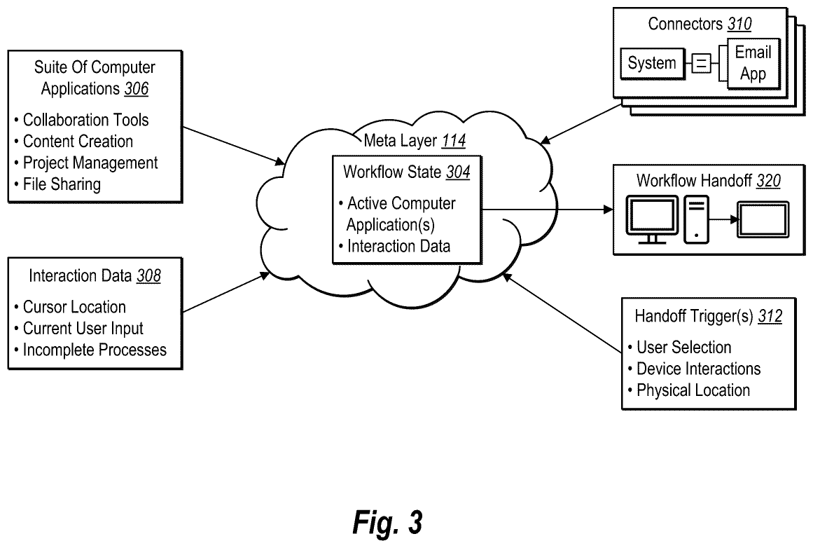

Relatedly, as used herein, the term “interaction data” refers to data indicating user interactions with the at least one active computer application on the particular client device. To illustrate, interaction data can include, but is not limited to, a cursor location, current user input (e.g., previously entered but incomplete or unsaved modifications or inputs), incomplete application processes (e.g., application processes or subroutines that were interrupted when the workflow handoff was initiated), and so forth. Additional examples of interaction data are provided below (e.g., in relation to FIG. 3).

As used herein, the term “handoff trigger” refers to an observed occurrence or detected signal indicating to the workflow continuance system when to transfer a workflow state from one device to another. Various examples of handoff triggers are provided below (e.g., in relation to FIG. 3).

As used herein, the term “machine learning model” refers to a computer algorithm or a collection of computer algorithms that automatically improve for a particular task through iterative outputs or predictions based on use of data. For example, a machine learning model can utilize one or more learning techniques to improve in accuracy and/or effectiveness. Example machine learning models include various types of neural networks, decision trees, support vector machines, linear regression models, and Bayesian networks. In some embodiments, the task catalyst system utilizes a large language machine learning model in the form of a neural network.

Relatedly, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., communication effectivity scores and/or video call effectiveness scores) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, or a generative adversarial neural network. Upon training as described below, such a neural network may become a large language model.

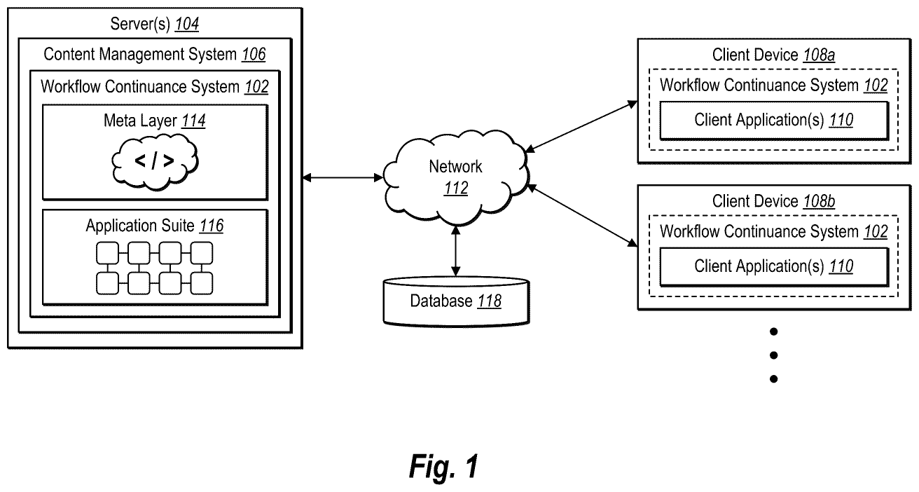

Additional detail regarding the workflow continuance system will now be provided with reference to the figures. For example, FIG. 1 illustrates a schematic diagram of an example system environment for implementing a workflow continuance system 102 in accordance with one or more implementations. An overview of the workflow continuance system 102 is described in relation to FIG. 1. Thereafter, a more detailed description of the components and processes of the workflow continuance system 102 is provided in relation to the subsequent figures.

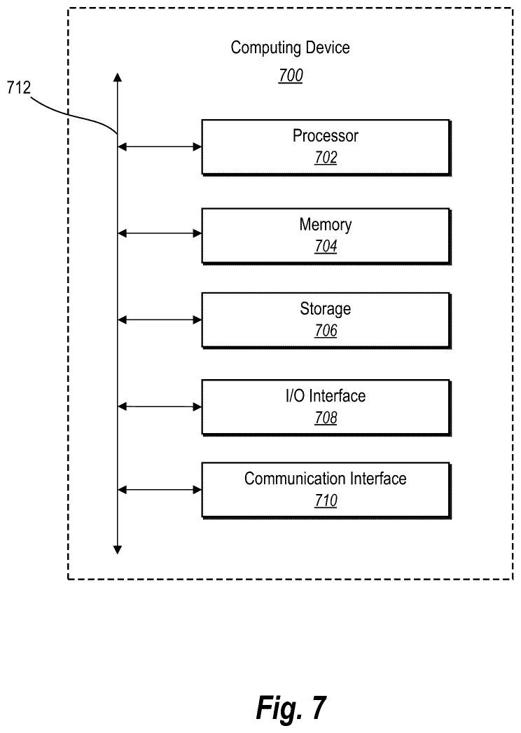

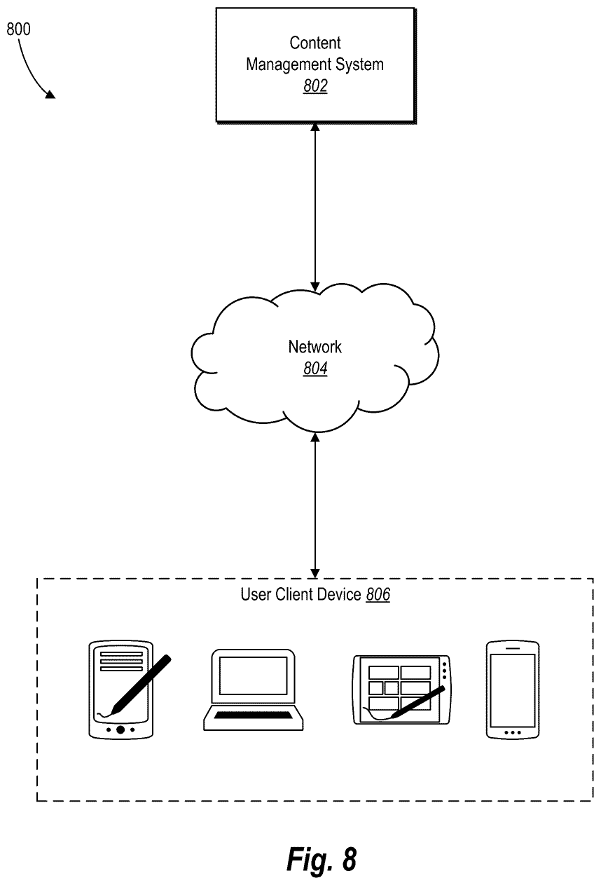

As shown, the environment includes server(s) 104, multiple client devices 108a, 108b, and so on, a database 118, and a network 112. Each of the components of the environment can communicate via the network 112, and the network 112 may be any suitable network over which computing devices can communicate. Example networks are discussed in more detail below in relation to FIGS. 7-8.

As mentioned above, the example environment includes client devices 108a and 108b—and as indicated in FIG. 1, additional client devices in at least some embodiments. The client devices 108a, 108b, and so forth can be one of a variety of computing devices, including a smartphone, a tablet, a smart television, a desktop computer, a laptop computer, a virtual reality device, an augmented reality device, or another computing device as described in relation to FIGS. 7-8. The client devices 108a, 108b, and so forth can communicate with the server(s) 104 and/or the database 118 via the network 112. For example, any of the client device 108a, 108b, and so on can receive user input from a user interacting with the respective client device (e.g., via the client application 110) to, for instance, access, generate, modify, or share a content item, to collaborate with a co-user of a different client device, or to select a user interface element. In addition, the workflow continuance system 102 on the server(s) 104 can receive information relating to various interactions with content items and/or user interface elements based on the input received by the respective client device.

As shown, each of the client devices 108a, 108b, and so on can include a client application 110. In particular, the client application 110 may be a web application, a native application installed on the client devices 108a, 108b, and so on (e.g., a mobile application, a desktop application, etc.), or a cloud-based application where all or part of the functionality is performed by the server(s) 104. Based on instructions from the client application 110, the respective client device 108a, 108b, or so on can present or display information, including a workflow handoff interface for transferring a workflow from one device to another.

As illustrated in FIG. 1, the example environment also includes the server(s) 104. The server(s) 104 may generate, track, store, process, receive, and transmit electronic data, such as digital content items, data source data, interface elements, interactions with digital content items, interactions with interface elements, and/or interactions between user accounts or client devices. For example, the server(s) 104 may receive data from any of the client devices 108a, 108b, and so forth in the form of a selection of a particular content item relating to a certain topic. In addition, the server(s) 104 can transmit data to the respective client device in the form of a content item, a handoff trigger, information within a workflow state, and/or instructions for instantiating a workflow state on one or more of the client devices 108a, 108b, and so on. Indeed, the server(s) 104 can communicate with the client devices 108a, 108b, and so on to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning server, and/or other types of servers.

As shown in FIG. 1, the server(s) 104 can also include the workflow continuance system 102 as part of a content management system 106. The content management system 106 can communicate with the client devices 108a, 108b, and so forth to perform various functions associated with the client application 110 such as managing user accounts, generating workflow states, monitoring for handoff triggers, transferring workflow states between devices, managing content items, and facilitating user interaction with the content collections and/or content items. Indeed, the content management system 106 can include a network-based smart cloud storage system to manage, store, and maintain content items and related data (including workflow state data) across numerous user accounts, including user accounts in collaboration with one another. In some embodiments, the workflow continuance system 102 and/or the content management system 106 utilize the database 118 to store and access information such as digital content items and workflow states.

As also illustrated in FIG. 1, the workflow continuance system 102 can include a meta layer 114 integrated with a suite of applications (e.g., an application suite 116 hosted by the content management system 106 or otherwise associated with the meta layer 114 across a computer network). In particular, the meta layer 114 can store and/or encode information defining relationships between applications within the application suite 116 and provide executable connections between the various functions of the application suite 116. To illustrate, the workflow continuance system 102 can utilize the meta layer 114 to define a workflow state defining an active computer application (e.g., of the application suite 116) on the client device 108a and interaction data within the active computer application. Moreover, the workflow continuance system 102 can utilizing the meta layer 114 to access the generated workflow state on another device, such as the client device 108b.

Although FIG. 1 depicts the workflow continuance system 102 located on the server(s) 104, in some implementations, the workflow continuance system 102 may be implemented (e.g., located entirely or in part) on one or more other components of the environment. For example, the workflow continuance system 102 may be implemented by the client device 108a, the client device 108b, another client device, and/or a third-party device. For example, one of the client devices 108a, 108b, and so forth can download all or part of the workflow continuance system 102 for implementation independent of, or together with, the server(s) 104.

In some implementations, though not illustrated in FIG. 1, the environment may have a different arrangement of components and/or may have a different number or set of components altogether. For example, the client devices 108a, 108b, and so forth may communicate directly with the workflow continuance system 102, bypassing the network 112. In addition, the environment can include the database 118 located external to the server(s) 104 (e.g., in communication via the network 112) or located on the server(s) 104 and/or on the client devices 108a, 108b, and so on. Further, the meta layer 114 can be located on the server(s) 104 as part of the content management system 106 or the workflow continuance system 102, or else can be located external to the server(s) 104 at another network location accessible by the workflow continuance system 102.

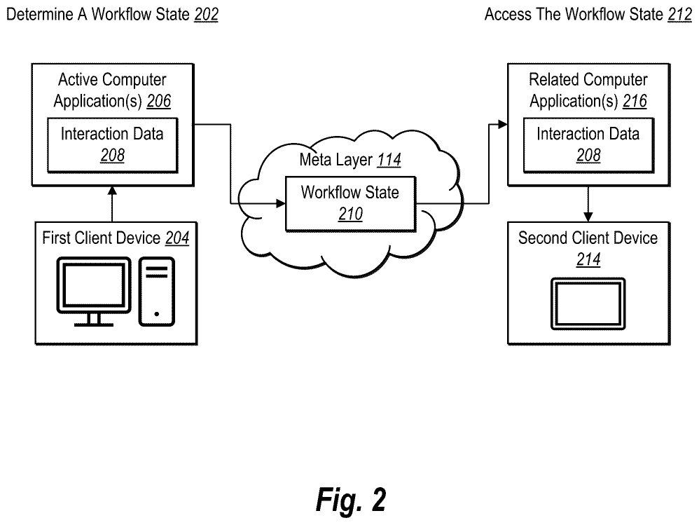

As mentioned above, the workflow continuance system 102 can generate and transfer workflow states between multiple devices. For example, FIG. 2 illustrates an example overview for generating a workflow state and transferring the generated workflow state from one device to another in accordance with one or more embodiments. Additional detail regarding the various acts and processes introduced in FIG. 2 is provided thereafter with reference to subsequent figures.

As illustrated in FIG. 2, the workflow continuance system 102 performs an act 202 of determining a workflow state for a first client device 204. For instance, the workflow continuance system 102 identifies one or more active computer applications 206 on the first client device 204. In some embodiments, for example, the one or more active computer applications 206 include computer applications which are presently open on the first client device 204, computer applications with open content items, computer applications currently processing information, and/or computer applications otherwise in an active status on the first client device 204. Alternatively, in one or more embodiments, the one or more active computer applications 206 are limited to applications presently accessing content items related to a particular topic, such as a particular task or project.

As also shown in FIG. 2, the workflow continuance system 102 determines interaction data 208 for the one or more active computer applications 206 on the first client device 204. In some embodiments, for example, the interaction data 208 includes real time indications of user interactions with an application (or content item accessed via an application) and/or a collection or stack of accumulated interactions (and their corresponding modifications) performed in a particular application session or a particular time period up to a current interaction. For instance, examples of the interaction data 208 include but are not limited to a current cursor location, a current pointer location, a current user input, or an incomplete application processes within the one or more active computer applications 206. Accordingly, the workflow continuance system 102 determines the interaction data 208 corresponding to each of the one or more active computer applications 206 on the first client device 204.

As further illustrated in FIG. 2, the workflow continuance system 102 generates a workflow state 210 defining the one or more active computer applications 206 of the first client device 204 and the interaction data 208 corresponding to the one or more active computer applications 206. As shown, the workflow continuance system 102 generates the workflow state 210 utilizing the meta layer 114 (e.g., a meta layer integrated with a suite of computer applications, as further described in relation to FIGS. 1 and 3), such that the workflow state 210 is accessible via the meta layer 114 on additional client devices.

Furthermore, in some embodiments, the workflow continuance system 102 identifies active computer applications across multiple client devices and corresponding interaction data when generating the workflow state 210. To illustrate, in an example implementation, the workflow continuance system 102 identifies an active document processing application and corresponding interaction data on a personal computer as well as an active note-taking application on a tablet device and includes both within the workflow state 210 of the meta layer 114.

As further shown in FIG. 2, the workflow continuance system 102 performs an act 212 of accessing the workflow state on a second client device 214. For instance, the workflow continuance system 102 identifies one or more related computer applications 216 on the second client device 214, such as computer applications corresponding to the one or more active computer applications 206 on the first client device. In some implementations, for example, related computer applications are identical computer applications (but different installations or versions) on different client devices. In some implementations, however, the one or more related computer applications 216 are different than the one or more active computer applications 206, although capable of opening content items accessed by the one or more active computer applications 206 (e.g., document processing applications provided by different developers but included within the suite of applications hosted by the content management system or otherwise interlinked). In some cases, the active computer applications 206 are for a first platform (e.g., desktop applications), and the related computer applications 216 are for a second platform (e.g., web-based applications or mobile applications), or vice-versa.

As also shown in FIG. 2, the workflow continuance system 102 accesses the workflow state 210 via the meta layer 114 to implement the interaction data 208 from the first client device 204 on the second client device 214 within the one or more related computer applications 216. In some embodiments, for example, the workflow continuance system 102 accesses the workflow state 210 to instantiate the one or more related computer applications 216 and implement the interaction data 208 therein. As mentioned, in one or more embodiments, the workflow continuance system 102 access the workflow state 210 in response to a handoff trigger comprising computer instructions for transferring the workflow state 210 from the first client device 204 to the second client device 214.

In some embodiments, the workflow continuance system 102 transfers workflow states across devices associated with different users, such as multiple users working in collaboration with one another. In certain implementations, for example, the second client device 214 comprises a collaborating client device associated with a different user than the first client device 204. More particularly, in some embodiments, the workflow continuance system 102 transfers the workflow state 210 of a first user account associated with the first client device 204 to a second user account associated with the second client device 214. Furthermore, in some embodiments, the workflow continuance system 102 updates the workflow state 210 with interaction data from both of the first and second client devices 204 and 214 to enable simultaneous workflow and/or collaboration across the respective devices.

As mentioned above, in one or more embodiments, the workflow continuance system 102 utilizes a meta layer integrated with a suite of computer applications (e.g., hosted by a content management system or otherwise interlinked) to generate and implement a workflow state defining workflow activity across multiple client device. To further illustrate, FIG. 3 shows the workflow continuance system 102 generating a workflow state 304 within the meta layer 114 and implementing the workflow state 304 across multiple client devices via a workflow handoff 320.

As shown in FIG. 3, the workflow continuance system 102 utilizes the meta layer 114 to generate and implement the workflow state 304 across multiple client devices. As noted, the meta layer 114 integrates a suite of computer applications 306, such as applications hosted by a content management system, such as the content management system 106. As illustrated, for example, the suite of computer applications 306 includes collaboration tools, content creation applications, project management applications, and file sharing applications. In some embodiments, the suite of computer applications 306 includes additional types of computer applications not listed in FIG. 3. Accordingly, in one or more embodiments, the workflow continuance system 102 identifies one or more active computer applications (e.g., active on one or more client devices connected to workflow continuance system 102) within the suite of computer applications 306 and indicates the identified active computer application(s) within the workflow state 304.

Furthermore, as shown in FIG. 3, the workflow continuance system 102 also determines interaction data 308 for the identified active computer application(s) and includes the interaction data 308 within the workflow state 304 at the meta layer 114. As shown, example elements of the interaction data 308 include but are not limited to a cursor location, a current user input, and incomplete applications processes (e.g., a partially completed application process). Accordingly, in one or more embodiments, the workflow continuance system 102 identifies the interaction data 308 from one or more connected client devices and indicates the interaction data 308 within the workflow state 304.

Moreover, in some embodiments, the workflow continuance system 102 integrates the meta layer 114 with the suite of computer applications 306 in a cross-compatible format for computer devices of different types, such as personal computers, mobile devices, tablet devices, and so forth. In doing so, the workflow continuance system 102 can define the workflow state 304 in a cross-compatible format for multiple different devices to enable implementation of the workflow state 304 on devices having different formats (e.g., screen sizes, operating system differences, etc.) via the meta layer 114 during the workflow handoff 320.

As also illustrated in FIG. 3, the workflow continuance system 102 utilizes one or more connectors 310 as a further integration of the meta layer 114 with one or more third-party applications. In particular, the workflow continuance system 102 utilizes computer code of a software connector to ingest data from an external, third-party computer applications. For example, the connectors 310 connect a third-party applications (e.g., applications hosted and executed outside of the content management system 106 and/or apart from the server(s) 104) to ingest data from the third-party applications. In some cases, the connectors 310 ingest data as a data stream or in a push-pull fashion based on API requests with the third-party applications. For instance, the connectors 310 extract or ingest data indicating interactions or activity with content items using third-party applications, such as an email application, a messaging application, a calendar application, a digital image editing application, or a web browser application. Ingested or extracted data can include identifiers for content items that are selected, modified, deleted, moved, or accessed, along with timestamps of the corresponding actions and user interactions.

As also shown, the workflow continuance system 102 detects one or more handoff trigger(s) 312 and, in response, performs the workflow handoff 320 to implement the workflow state 304—defining active computer applications and interaction data from one or more client devices—on one or more subsequent client devices. As shown, example of the handoff trigger(s) 312 include but are not limited to user selections, device interactions, or physical locations of users and/or devices. A user selection, for example, can include a user interaction with a selectable option for transferring a workflow state from one device to another (e.g., a selectable option presented on the originating device and/or the device to which the workflow state will be transferred). Device interactions, for example, can include a user interaction with another device (e.g., picking up or turning on a device other than the currently active device) or interactions between devices (e.g., detected movement of a peripheral device or other device via an IMU, a GPS sensor, or other sensor of motion or touch). Physical locations, for example, can include detection of a physical location of a user, a client device, and/or a peripheral device utilizing a GPS sensor associated with the person or device and/or near field communication (NFC) enabled devices.

Moreover, in some embodiments, the workflow continuance system 102 can present a selectable option for the workflow handoff 320 in response to one of the handoff triggers 312. For example, in some embodiments, the workflow continuance system 102 detects an idle status of a first client device (e.g., a device upon which the workflow state 304 originates) and/or an active status of a second client device and, in response, provides a selectable option via a user interface on the second client device for initiating the workflow handoff 320. Alternatively, in some embodiments, the workflow continuance system 102 can automatically transfer the workflow state 304 between devices when a newly active status is detected on a client device (e.g., according to a user preference).

Accordingly, in response to one or more of the handoff triggers 312, the workflow continuance system 102 can implement the workflow handoff 320 to access the workflow state 304 on a subsequent device. Furthermore, in one or more embodiments, the workflow continuance system 102 generates one or more suggested actions related to the workflow state 304 as part of the workflow handoff 320. In such embodiments, for example, the workflow continuance system 102 can utilize a machine learning model or neural network trained to predict a next step in a workflow corresponding to a current workflow state.

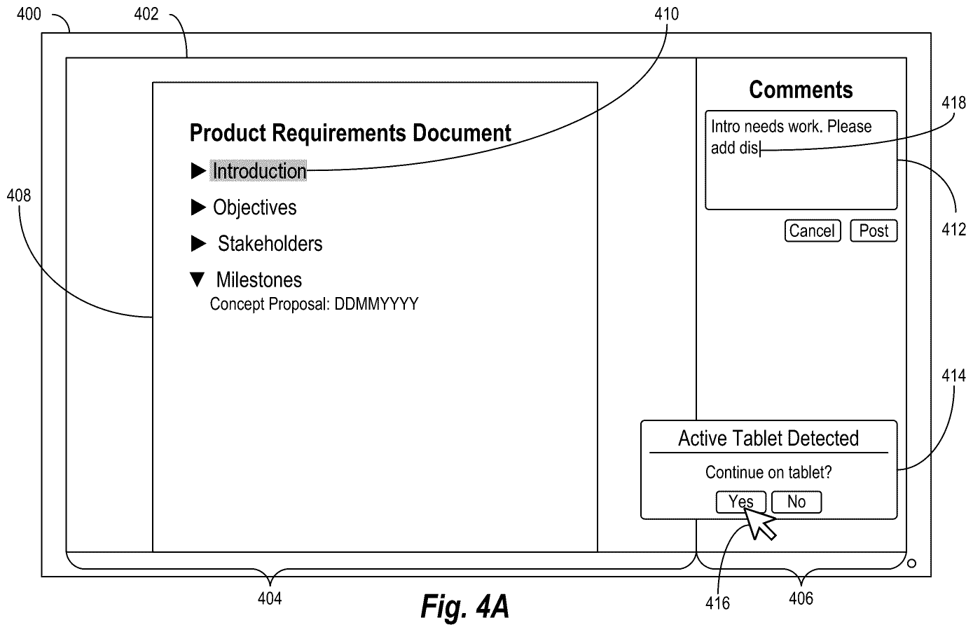

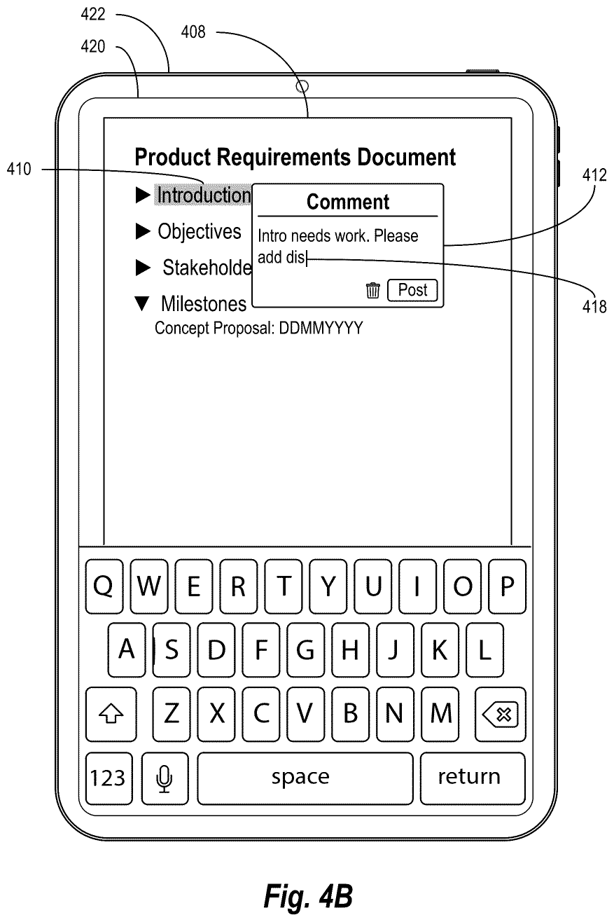

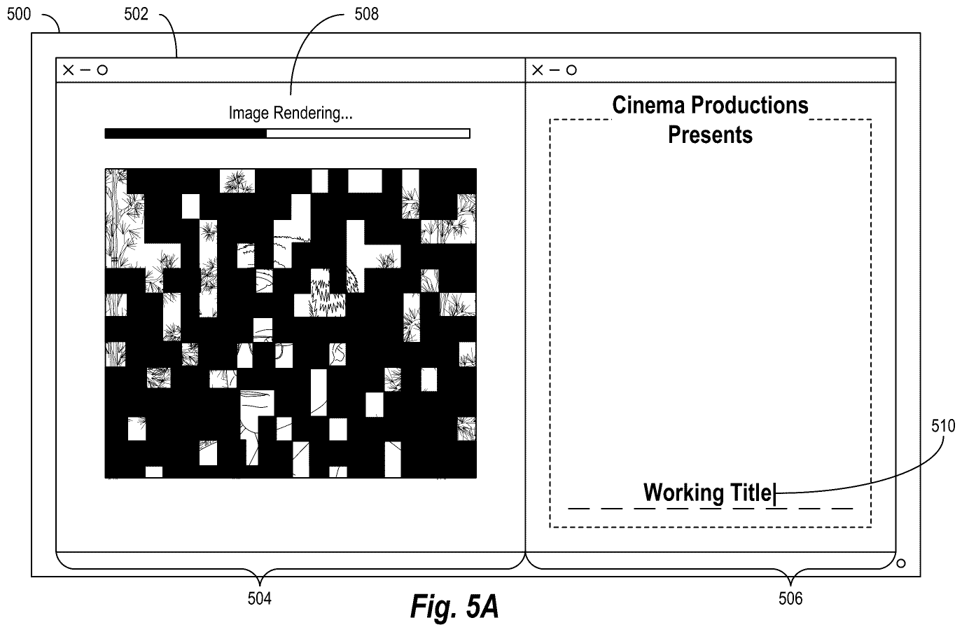

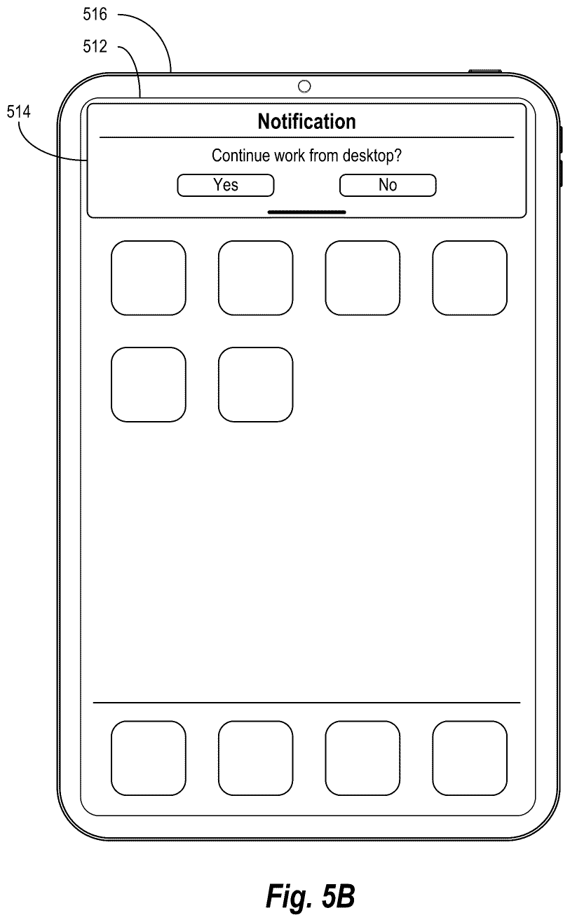

As mentioned above, in one or more embodiments, the workflow continuance system 102 generates and implements workflow states across multiple devices. Also, in some embodiments, the workflow continuance system 102 implements workflow states across different types of devices, such as devices comprising different formats, operating systems, and so forth. For example, FIGS. 4A-4B and 5A-5B illustrate various example user interfaces on various client devices for generating and implementing workflow states according to one or more embodiments. More particularly, FIGS. 4A-4B illustrate the workflow continuance system 102 transferring an application-specific workflow state from a first client device 400 (e.g., a desktop computer) to a second client device 422 (e.g., a tablet device) in response to detecting a user interaction with a selectable option 414 presented on the first client device 400. Along similar lines, FIGS. 5A-5B illustrate the workflow continuance system 102 transferring a global workflow state (e.g., defining multiple active computer applications) from a first client device 500 (e.g., a desktop computer) to a second client device 516 (e.g., a tablet device) in response to a selectable option 514 presented on the second client device 516.

As shown in FIG. 4A, the first client device 400 comprises a user interface 402 provided on a display (e.g., a screen). Within the user interface 402, an active application window 404 shows a document 408 and a corresponding sidebar 406 for displaying document editing and/or collaboration tools, such as a comment entry box 412 for posting comments in relation to the document 408. As illustrated, for example, the user interface 402 includes a highlighted text 410 within the document 408 and a corresponding unposted comment within the comment entry box 412.

While FIG. 4A shows elements of interaction data within a document processing application, embodiments can include comments, edits, and other interactions with various types of computer applications, such as but not limited to software development, image processing, movie editing, or music production software. Indeed, in some embodiments, interaction data can include various types of user inputs/interactions, partially complete user inputs/interactions, and/or setting, selections, conditions, or states resulting from such user inputs/interactions. In some implementations, for example, a workflow state can include incomplete user interactions such as but not limited to opened drop-down or pop-up windows in which a user has not yet completed their selection of one or more options (e.g., changes to formatting, selection of available tools, incomplete selections for importing documents, images, audio, colors, instruments, or other selectable options within the respective computer application). Furthermore, in some embodiments, the workflow continuance system 102 utilizes a trained machine learning model to predict a next probable action for consideration by a user when transferring the workflow state to another device.

As mentioned, in one or more embodiments, the workflow continuance system 102 generates a workflow state defining an active computer application and interaction data within the active computer application on a client device. As shown in FIG. 4A, for example, the workflow continuance system 102 can generate a workflow state defining the computer program corresponding to the active application window 404 and interaction data including the highlighted text 410, the unposted comment within the comment entry box 412, and a cursor location within the document 408 or, as shown in FIG. 4A a location of a cursor 418 within the comment entry box 412. Further, in some embodiments, the workflow state generated by the workflow continuance system 102 includes additional active computer applications and/or interaction data not presently on display within the user interface 402 of the first client device 400, thus defining a global workflow state in lieu of an application-specific workflow state.

As further shown in FIG. 4A, the workflow continuance system 102 provides the selectable option 414 for continuing the workflow state from the first client device 400 on another client device (e.g., the second client device 422). As shown, by selecting the selectable option 414 (e.g., using a mouse pointer 416), a user can implement the workflow state on another client device. As discussed in greater detail above, in some embodiments, the workflow continuance system 102 can detect a variety of different handoff triggers to trigger a workflow handoff between devices (e.g., as described above in relation to FIG. 3).

As shown in FIG. 4B, in response to detecting a user interaction with the selectable option 414 on the first client device 400, the workflow continuance system 102 implements the application-specific workflow state by instantiating the active computer application of the active application window 404, on the second client device 422. Accordingly, as shown in FIG. 4B, a user interface 420 of the second client device 422 includes a display of the document 408 with the highlighted text 410 and the corresponding unposted comment within the comment entry box 412. In contrast to the sidebar 406, however, the user interface 420 of the second client device 422 displays the comment entry box 412 as an overlaid prompt (e.g., a pop-up window). Further, the user interface 420 of the second client device 422 also displays the cursor 418 at the same cursor location at which it was located on the user interface 402 of the first client device 400. Indeed, the computer application running on the second client device 422 is not the same as that on the first client device 400 (e.g., a mobile version or a web version). The workflow continuance system 102 thus opens the computer application, accesses the necessary content item, and instantiates a state of the content item defined by the workflow state from the first client device 400. Accordingly, as shown in FIGS. 4A-4B, the workflow continuance system 102 implements the unposted comment within the comment entry box 412 in the same incomplete form across the different client devices, such that a user is not required to complete or post unfinished work prior to a workflow handoff.

As shown in FIG. 5A, the workflow continuance system 102 can generate a global workflow state defining multiple active computer applications and corresponding interaction data on a client device for transference to another client device. As illustrated, the first client device 500 includes a user interface 502 displaying a first active application window 504, wherein a digital image is in the process of rendering, and a second active application window 506 comprising a document presently undergoing an edit. Accordingly, in the implementation shown, the workflow continuance system 102 identifies the active computer applications corresponding to the first and second active application window 504 and 506, respectively, and determines interaction data including an incomplete application process 508 (e.g., a presently running image rendering process) and a cursor location 510 within the document of the second active application window 506.

As mentioned above, in some embodiments, the workflow continuance system 102 generates a workflow state including additional active computer applications and/or interaction data not presently on display within the user interface 502 of the first client device 500. In some implementations, for example, additional active computer applications running in the background (e.g., not currently displayed within the user interface 502 of the first client device 500) can include additional content editing software having partially completed inputs (e.g., unsubmitted user comments) and/or incomplete application processes, such as but not limited to additional image/movie creation applications presently rendering content, computer coding software presently compiling source code, a science/engineering analysis platform presently processing an analysis subroutine, a content management application presently downloading a copy of a content item, an incomplete online submission, or an incomplete transaction (e.g., a partially completed checkout where incomplete or partial payment information is saved as part of a workflow state or an ongoing drawing or edit on a video frame in Dropbox Replay). Indeed, the workflow continuance system 102 can save a workflow state mid-action by saving a state of interaction in one or more applications, such as an open view of a font selection menu during a selection process, a view of an open paragraph formatting window while changing settings (but before saving or applying). Accordingly, upon transferring a workflow state comprising an incomplete computer application to a second client device, the workflow continuance system 102 can instantiate each active computer application on the second client device, including any interrupted incomplete application processes identified within the workflow state.

As shown in FIG. 5B, the workflow continuance system 102 provides the selectable option 514 for workflow continuance within a user interface 512 of the second client device 516. Accordingly, in response to detecting a user interaction with the selectable option 514 (e.g., a finger press on the displayed “Yes” icon), the workflow continuance system 102 implements the workflow state on the second client device 516, including the cursor location 510 within the document presently displayed on the first client device 500, as well as a continuation of the incomplete application process 508 on the second client device 516. In some embodiments, continuation of incomplete application processes is only optionally implemented on the second client device 516. Moreover, in some embodiments, the workflow continuance system 102 generates a version history of workflow states over time and presents the second client device 516 with selectable options for continuing one of a plurality of workflow states saved within the version history. While FIG. 5B shows the selectable option 514 as part of a pop-up notification near the top of the user interface 512, in some embodiments the workflow continuance system 102 presents a selectable option and/or a notification of workflow transference via a passive element of a user display (e.g., a portion of a user interface or a separate interface designated for notifications and/or other cursory functions). In some cases, a passive element includes or refers to a portion of a display screen designated to display content or functional elements apart from (but sometimes related to) content presented in active portions of the display depicting user interfaces (whereas a passive element does not present the same user interfaces).

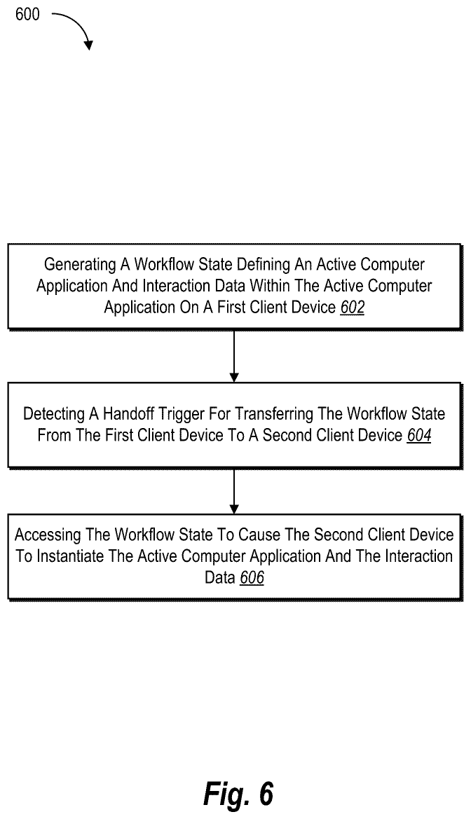

FIGS. 1-3, 4A-4B, 5A-5B, the corresponding text, and the foregoing examples provide a number of different systems and methods for generating and implementing workflow states across multiple devices in accordance with one or more embodiments. In addition to the foregoing, implementations can also be described in terms of flowcharts comprising acts steps in a method for accomplishing a particular result. For example, FIG. 6 illustrates an example series of acts for generating a workflow state for a first client device and accessing that workflow state on a second client device, in accordance with one or more embodiments.

While FIG. 6 illustrates acts according to certain implementations, alternative implementations may omit, add to, reorder, and/or modify any of the acts shown in FIG. 6. The acts of FIG. 6 can be performed as part of a method. Alternatively, a non-transitory computer readable medium can comprise instructions, that when executed by one or more processors, cause a computing device to perform the acts of FIG. 6. In still further implementations, a system can perform the acts of FIG. 6.

As illustrated in FIG. 6, the series of acts 600 may include an act 602 of generating a workflow state defining an active computer application and interaction data within the active computer application on a first client device, an act 604 of detecting a handoff trigger for transferring the workflow state from the first client device to a second client device, and an act 606 of accessing the workflow state to cause the second client device to instantiate the active computer application and the interaction data.

In some embodiments, for example, the series of acts 600 includes generating, utilizing a meta layer integrated with a suite of computer applications, a workflow state defining an active computer application and interaction data within the active computer application on a first client device, detecting a handoff trigger related to transferring the workflow state from the first client device to a second client device, and, in response to detecting the handoff trigger, accessing, via the meta layer, the workflow state to cause the second client device to instantiate the active computer application and the interaction data.

Further, in some embodiments, the interaction data comprises one or more of a current cursor location, a current user input, or an incomplete application process within the active computer application on the first client device and the workflow state further defines the interaction data for a related computer application of the second client device corresponding to the active computer application of the first client device. In one or more embodiments, generating the workflow state also includes defining, within the meta layer and based on the interaction data, the workflow state for the related computer application of the second client device corresponding to the active computer application of the first client device.

Additionally, in some embodiments, the series of acts 600 includes determining additional interaction data within at least one additional computer application on the first client device and generating an updated workflow state defining the active computer application, the interaction data, the at least one additional computer application, and the additional interaction data. In one or more embodiments, accessing the workflow state further causes the second client device to instantiate the at least one additional computer application and the additional interaction data.

Moreover, in some embodiments, the series of acts 600 further includes detecting the handoff trigger by detecting a user interaction with a selectable option for workflow continuance on the second client device. In addition, in some embodiments, the series of acts 600 includes detecting an idle status of the first client device and an active status of the second client device and, in response, providing, via a user interface of the second client device, the selectable option for workflow continuance on the second client device. In one or more embodiments, the series of acts 600 further includes detecting a user interaction with at least one of the second client device or a peripheral device associated with the second client device and providing, via a user interface of the second client device, the selectable option for workflow continuance on the second client device.

In some embodiments, the series of acts 600 includes generating, utilizing a meta layer integrated with a suite of computer applications available on multiple devices connected to a network, a workflow state defining an active computer application and interaction data within the active computer application on a first client device, detecting a handoff trigger configured to prompt a transfer of the workflow state from the first client device to a second client device, and, in response to detecting the handoff trigger, causing the second client device to instantiate the active computer application and the interaction data according to the workflow state of the meta layer.

Furthermore, in some embodiments, the series of acts 600 includes integrating the meta layer with a plurality of related applications in a cross-compatible format for computer devices of different device types including one or more of personal computers, mobile devices, or tablet devices. Also, in some embodiments, the workflow state further defines additional computer applications and respective interaction data within the additional computer applications on the first client device. In addition, in some embodiments, the series of acts 600 further includes generating the workflow state for a particular work topic by identifying, within global interaction data on the first client device, the interaction data within the active computer application and the respective interaction data within the additional computer applications as related to the particular work topic.

Moreover, in some embodiments, the series of acts 600 also includes generating the workflow state by defining the interaction data within the active computer application in an alternative format for a related application of the suite of computer application installed on the second client device.

In addition, in some embodiments, the series of acts 600 includes detecting the handoff trigger by identifying the second client device as corresponding to a second user associated with a first user of the first client device, providing, via a user interface of the second client device, a selectable option for workflow continuance on the second client device, and detecting a user interaction with the selectable option for workflow continuance by the second user on the second client device. Further, in some embodiments, the series of acts 600 includes maintaining the workflow state with additional interaction data as the first user and the second user interact with the active computer application.

In some embodiments, the series of acts 600 includes generating, in response to detecting a user interaction with an active computer application on a first client device, a workflow state defining the active computer application and interaction data within the active computer application on the first client device, detecting a handoff trigger related to transferring the workflow state from the first client device to a second client device, and, in response to detecting the handoff trigger, access, via a meta layer integrated with a suite of computer applications hosted by the content management system, the workflow state to cause the second client device to instantiate the active computer application and the interaction data.

Furthermore, in some embodiments, the series of acts 600 also includes instantiating the active computer application and the interaction data on the second client device by converting at least a portion of the interaction data to an interface format of the second client device. In one or more embodiments, the series of acts 600 also includes detecting the handoff trigger by detecting at least one of a user interaction with the second client device, a user interaction with a peripheral device, a user interaction with a selectable option for workflow continuance on the second client device, a change in geolocation of a user associated with the workflow state, or an idle status of the first client device.

Moreover, in some embodiments, the series of acts 600 also includes generating the workflow state by defining at least one additional computer application and respective interaction data within the at least one additional computer application in relation to the interaction data within the active computer application on the first client device. In addition, in some embodiments, the series of acts 600 also includes providing, via a user interface on at least one of the first client device or the second client device, selectable options for instantiating one or more of the active computer application or the at least one additional computer application on the second client device according to the workflow state.

The components of the workflow continuance system 102 can include software, hardware, or both. For example, the components of the workflow continuance system 102 can include one or more instructions stored on a computer-readable storage medium and executable by processors of one or more computing devices. When executed by one or more processors, the computer-executable instructions of the workflow continuance system 102 can cause a computing device to perform the methods described herein. Alternatively, the components of the workflow continuance system 102 can comprise hardware, such as a special purpose processing device to perform a certain function or group of functions. Additionally or alternatively, the components of the workflow continuance system 102 can include a combination of computer-executable instructions and hardware.

Furthermore, the components of the workflow continuance system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the workflow continuance system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates a block diagram of exemplary computing device 700 (e.g., the server(s) 104 and/or the client devices 108a, 108b, and so forth) that may be configured to perform one or more of the processes described above. One will appreciate that server(s) 104 and/or the client devices 108a, 108b, and so on may comprise one or more computing devices such as computing device 700. As shown by FIG. 7, computing device 700 can comprise processor 702, memory 704, storage device 706, I/O interface 708, and communication interface 710, which may be communicatively coupled by way of communication infrastructure 712. While an exemplary computing device 700 is shown in FIG. 7, the components illustrated in FIG. 7 are not intended to be limiting. Additional or alternative components may be used in other implementations. Furthermore, in certain implementations, computing device 700 can include fewer components than those shown in FIG. 7. Components of computing device 700 shown in FIG. 7 will now be described in additional detail.

In particular implementations, processor 702 includes hardware for executing instructions, such as those making up a computer program. As an example and not by way of limitation, to execute instructions, processor 702 may retrieve (or fetch) the instructions from an internal register, an internal cache, memory 704, or storage device 706 and decode and execute them. In particular implementations, processor 702 may include one or more internal caches for data, instructions, or addresses. As an example and not by way of limitation, processor 702 may include one or more instruction caches, one or more data caches, and one or more translation lookaside buffers (TLBs). Instructions in the instruction caches may be copies of instructions in memory 704 or storage device 706.

Memory 704 may be used for storing data, metadata, and programs for execution by the processor(s). Memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 704 may be internal or distributed memory.

Storage device 706 includes storage for storing data or instructions. As an example and not by way of limitation, storage device 706 can comprise a non-transitory storage medium described above. Storage device 706 may include a hard disk drive (HDD), a floppy disk drive, flash memory, an optical disc, a magneto-optical disc, magnetic tape, or a Universal Serial Bus (USB) drive or a combination of two or more of these. Storage device 706 may include removable or non-removable (or fixed) media, where appropriate. Storage device 706 may be internal or external to computing device 700. In particular implementations, storage device 706 is non-volatile, solid-state memory. In other implementations, Storage device 706 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 708 allows a user to provide input to, receive output from, and otherwise transfer data to and receive data from computing device 700. I/O interface 708 may include a mouse, a keypad or a keyboard, a touch screen, a camera, an optical scanner, network interface, modem, other known I/O devices or a combination of such I/O interfaces. I/O interface 708 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 708 is configured to provide graphical data to a display for presentation to a user. The graphical data may be representative of one or more graphical user interfaces and/or any other graphical content as may serve a particular implementation.

Communication interface 710 can include hardware, software, or both. In any event, communication interface 710 can provide one or more interfaces for communication (such as, for example, packet-based communication) between computing device 700 and one or more other computing devices or networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 710 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 710 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 710 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 712 may include hardware, software, or both that couples components of computing device 700 to each other. As an example and not by way of limitation, communication infrastructure 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 8 is a schematic diagram illustrating environment 800 within which one or more implementations of the workflow continuance system 102 can be implemented. For example, the workflow continuance system 102 may be part of a content management system 802 (e.g., the content management system 106). Content management system 802 may generate, store, manage, receive, and send digital content (such as digital content items). For example, content management system 802 may send and receive digital content to and from client devices 806 by way of network 804. In particular, content management system 802 can store and manage a collection of digital content. Content management system 802 can manage the sharing of digital content between computing devices associated with a plurality of users. For instance, content management system 802 can facilitate a user sharing a digital content with another user of content management system 802.

In particular, content management system 802 can manage synchronizing digital content across multiple client devices 806 associated with one or more users. For example, a user may edit digital content using client device 806. The content management system 802 can cause client device 806 to send the edited digital content to content management system 802. Content management system 802 then synchronizes the edited digital content on one or more additional computing devices.

In addition to synchronizing digital content across multiple devices, one or more implementations of content management system 802 can provide an efficient storage option for users that have large collections of digital content. For example, content management system 802 can store a collection of digital content on content management system 802, while the client device 806 only stores reduced-sized versions of the digital content. A user can navigate and browse the reduced-sized versions (e.g., a thumbnail of a digital image) of the digital content on client device 806. In particular, one way in which a user can experience digital content is to browse the reduced-sized versions of the digital content on client device 806.

Another way in which a user can experience digital content is to select a reduced-size version of digital content to request the full-or high-resolution version of digital content from content management system 802. In particular, upon a user selecting a reduced-sized version of digital content, client device 806 sends a request to content management system 802 requesting the digital content associated with the reduced-sized version of the digital content. Content management system 802 can respond to the request by sending the digital content to client device 806. Client device 806, upon receiving the digital content, can then present the digital content to the user. In this way, a user can have access to large collections of digital content while minimizing the number of resources used on client device 806.

Client device 806 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. Client device 806 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 804.

Network 804 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 806 may access content management system 802.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating, utilizing a meta layer integrated with a suite of computer applications, a workflow state defining an active computer application and interaction data within the active computer application on a first client device;
detecting a handoff trigger related to transferring the workflow state from the first client device to a second client device; and
in response to detecting the handoff trigger, accessing, via the meta layer, the workflow state to cause the second client device to instantiate the active computer application and the interaction data.

2. The computer-implemented method of claim 1, wherein:
the interaction data comprises one or more of a current cursor location, a current user input, or an incomplete application process within the active computer application on the first client device; and
the workflow state further defines the interaction data for a related computer application of the second client device corresponding to the active computer application of the first client device.

3. The computer-implemented method of claim 2, wherein generating the workflow state further comprises defining, within the meta layer and based on the interaction data, the workflow state for the related computer application of the second client device corresponding to the active computer application of the first client device.

4. The computer-implemented method of claim 1, further comprising:
determining additional interaction data within at least one additional computer application on the first client device; and
generating an updated workflow state defining the active computer application, the interaction data, the at least one additional computer application, and the additional interaction data.

5. The computer-implemented method of claim 4, wherein accessing the workflow state further causes the second client device to instantiate the at least one additional computer application and the additional interaction data.

6. The computer-implemented method of claim 1, wherein detecting the handoff trigger comprises detecting a user interaction with a selectable option for workflow continuance on the second client device.

7. The computer-implemented method of claim 6, further comprising:
detecting an idle status of the first client device and an active status of the second client device; and
in response, providing, via a user interface of the second client device, the selectable option for workflow continuance on the second client device.

8. The computer-implemented method of claim 6, further comprising:
detecting a user interaction with at least one of the second client device or a peripheral device associated with the second client device; and
providing, via a user interface of the second client device, the selectable option for workflow continuance on the second client device.

9. A system comprising:
at least one processor; and
a non-transitory computer readable medium comprising instructions that, when executed by the at least one processor, cause the system to:
generate, utilizing a meta layer integrated with a suite of computer applications available on multiple devices connected to a network, a workflow state defining an active computer application and interaction data within the active computer application on a first client device;
detect a handoff trigger comprising computer instructions configured to prompt a transfer of the workflow state from the first client device to a second client device; and
in response to detecting the handoff trigger, cause the second client device to instantiate the active computer application and the interaction data according to the workflow state of the meta layer.

10. The system of claim 9, further comprising instructions that, when executed by the at least one processor, cause the system to integrate the meta layer with a plurality of related applications in a cross-compatible format for computer devices of different device types including one or more of personal computers, mobile devices, or tablet devices.

11. The system of claim 10, wherein the workflow state further defines additional computer applications and respective interaction data within the additional computer applications on the first client device.

12. The system of claim 11, further comprising instructions that, when executed by the at least one processor, cause the system to generate the workflow state for a particular work topic by identifying, within global interaction data on the first client device, the interaction data within the active computer application and the respective interaction data within the additional computer applications as related to the particular work topic.

13. The system of claim 9, wherein generating the workflow state comprises defining the interaction data within the active computer application in an alternative format for a related application of the suite of computer application installed on the second client device.

14. The system of claim 9, wherein detecting the handoff trigger comprises:
identifying the second client device as corresponding to a second user associated with a first user of the first client device;
providing, via a user interface of the second client device, a selectable option for workflow continuance on the second client device; and
detecting a user interaction with the selectable option for workflow continuance by the second user on the second client device.

15. The system of claim 14, further comprising instructions that, when executed by the at least one processor, cause the system to maintain the workflow state with additional interaction data as the first user and the second user interact with the active computer application.

16. A non-transitory computer readable medium comprising instructions that, when executed by at least one processor, cause the at least one processor to:
generate, in response to detecting a user interaction with an active computer application on a first client device, a workflow state defining the active computer application and interaction data within the active computer application on the first client device;
detect a handoff trigger related to transferring the workflow state from the first client device to a second client device; and
in response to detecting the handoff trigger, access, via a meta layer integrated with a suite of computer applications hosted by a content management system, the workflow state to cause the second client device to instantiate the active computer application and the interaction data.

17. The non-transitory computer readable medium of claim 16, wherein instantiating the active computer application and the interaction data on the second client device comprises converting at least a portion of the interaction data to an interface format of the second client device.

18. The non-transitory computer readable medium of claim 16, wherein detecting the handoff trigger comprises detecting at least one of a user interaction with the second client device, a user interaction with a peripheral device, a user interaction with a selectable option for workflow continuance on the second client device, a change in geolocation of a user associated with the workflow state, or an idle status of the first client device.

19. The non-transitory computer readable medium of claim 16, wherein generating the workflow state further comprises defining at least one additional computer application and respective interaction data within the at least one additional computer application in relation to the interaction data within the active computer application on the first client device.

20. The non-transitory computer readable medium of claim 19, further comprising instructions that, when executed by the at least one processor, cause the at least one processor to provide, via a user interface on at least one of the first client device or the second client device, selectable options for instantiating one or more of the active computer application or the at least one additional computer application on the second client device according to the workflow state.
